(19) United States
(12) Patent Application Publication
(10) Pub. No.: US 2020/0020202 A1
(43) Pub. Date: Jan. 16, 2020

(54) SPORTS BINGO GAME OPERATION METHOD REFLECTING REAL-TIME SPORTS GAME RESULT

(71) Applicants: Young-Hoon Kim, Gyeonggi-do (KR); Yong-Hyuk Chang, Gyeonggi-do (KR); RANKINGBALL, INC., Santa Clara, CA (US)

(72) Inventors: Young-Hoon Kim, Gyeonggi-do (KR); Yong-Hyuk Chang, Gyeonggi-do (KR)

(21) Appl. No.: 16/483,988

(22) PCT Filed: Feb. 5, 2018
(86) PCT No.: PCT/KR2018/001507

§ 371 Date: Aug. 6, 2019

(30) Foreign Application Priority Data
Feb. 6, 2017 (KR) 10-2017-0016335
Dec. 18, 2017 (KR) 10-2017-0174336
Dec. 20, 2017 (KR) 10-2017-0175884

(51) Int. Cl. G07F 17/32; A63F 13/46

(52) U.S. Cl. CPC G07F 17/3288; A63F 13/46; G07F 17/3279; G07F 17/329

(57) ABSTRACT

A sports bingo game operation method implemented by at least one data processor provided in a computing device capable of communicating with a client terminal of each user, includes generating, by the data processor, a bingo game of each user including at least N×N (N is a natural number of 3 or greater) tiles related to a sports game performance, determining, by the data processor, whether each of the tiles is daubed and the daubed tiles complete a bingo according to the sports game information according to sports game information, and determining a ranking of each user on the basis of points related to the daubed tiles and points related to the completed bingo.

### TECHNICAL FIELD

The present invention relates to a sports bingo game operation method, and more particularly, to a sports bingo game operation method reflecting real-time sports game results, which allows users participating in a bingo game to move positions of one or more of tiles in which daubing conditions regarding the sports game results are set so that users' knowledge and analysis of the sports game result to more dominantly affect the bingo game.

### BACKGROUND ART

Recently, with the rapid development of information communication technologies, network systems have also been rapidly developed and the Internet of the network systems has been explosively prevalent to provide various types of services. Among them, an online game market has rapidly been increased in development rate and spread rate due to the spread of demand.

In general, a bingo game is a game in which one of several topics is set in a table with lines and spaces having a predetermined standard and a plurality of bingo game users fill the table with what they know and match the contents arbitrarily and selectively called by a host or a user by turns to quickly connect them horizontally, vertically, and diagonally. As the game method is universally known, the bingo game is a representative game which may be easily enjoyed even without separate explanation of the game method.

However, a service for setting up sports results in a general bingo game and operating a bingo game reflecting the real-time sports game results has not been provided.

### DISCLOSURE

### Technical Problem

An aspect of the present invention provides a sports bingo game operation method reflecting real-time sports game results, in which a bingo game composed of tiles (or grids) in which daubing conditions regarding sports game results are set is provided to users who participate in the same contest, the users are allowed to move positions of one or more of tiles so that the users' knowledge and analysis on the sports game results dominantly affect the bingo game, and results of a contest are calculated by reflecting the number of tiles satisfying the daubing conditions and the number of bingos achieved by the tiles on the basis of the sports game results included in real-time sports data.

In addition, the present invention is based on the sports result included in the real-time sports data, the number and the number of tiles for which the daubing condition is satisfied, the number of the bingo achieved by the tile, And the result of the contest is calculated by reflecting the result of the sports bingo game.

Another aspect of the present invention provides a sports bingo game operation method reflecting real-time sports game results, in which results of a contest are calculated by reflecting the number and the number of times of tiles satisfying daubing conditions, the number of bingos achieved by the tiles, and the number of times of achievements (completions) of bingo on the basis of the sports game results included in real-time sports data.

Another aspect of the present invention provides a sports bingo game operation method reflecting real-time sports game results, in which tiles included in one bingo game includes a plurality of daubing conditions so that bingos can be completed under various daubing conditions.

### Technical Solution

According to an aspect of the present invention, there is provided a sports bingo game operation method implemented by at least one data processor provided in a computing device capable of communicating with a client terminal of each user, including: generating, by the data processor, a bingo game of each user including at least N×N (N is a natural number of 3 or greater) tiles related to a sports game performance; determining, by the data processor, whether each of the tiles is daubed and the daubed tiles complete a bingo according to the sports game information according to sports game information; and determining a ranking of each user on the basis of points related to the daubed tiles and points related to the completed bingo.

The sports bingo game operation method may further include: changing, by the data processor, an arrangement position of at least two or more tiles according to a movement command to update the bingo game, wherein the determining may include determining whether each of the tiles is daubed for the updated bingo game and whether the daubed tiles complete bingo.

Further, the points related to the daubed tiles may be related to the number of the daubed tiles.

Further, the points related to the completed bingo may be related to the number of the completed bingo.

Further, the points related to the daubed tiles may be related to the number of the daubed tiles and the number of times the tiles are daubed.

Further, the points related to the completed bingo may be related to the number of the completed bingo and the number of times the bingos are completed.

Further, the determining may include: determining, by the processor, a ranking by applying a weight according to bingo directions of tiles completing the bingo.

The sports bingo game operation method may further include: storing, by the data processor, a gamer or a team lineup prepared by a user for a contest of a sports event selected by the user before the generating of the bingo game.

Further, the storing may include: calculating a point related to a time required for determining the gamer lineup or a remaining time for completing lineup registration and storing the calculated point.

Further, the generating of the bingo game may include: generating, by the data processor, the bingo game such that each tile includes a plurality of daubing conditions.

Further, the determining may include: determining, by the data processor, whether each of the plurality of daubing conditions of the tile is daubed and determining whether the daubed tiles complete the bingo with the same daubing condition.

Further, the generating of the bingo game may include: generating, by the data processor, the bingo game such that each tile includes a plurality of daubing conditions and a daubing condition position of each of the plurality of daubing conditions.

The sports bingo game operation method may further include: updating, by the data processor, the bingo game by changing a condition arrangement position of the daubing conditions of a designated tile according to a change command of the condition arrangement position.

Further, the determining may include: determining, by the data processor, whether each of the plurality of daubing conditions of the tile is daubed and determining whether the daubed tiles complete the bingo with the same daubing condition and daubing condition position.

The ranking determining may include: determining the ranking on the basis of a point related to a time required for determining the gamer lineup or a remaining time for completing lineup registration, a point related to the completed bingo, at least one of points related to tiles not included in the completed bingo, and a fantasy point of gamers included in the lineup.

### Advantageous Effects

According to the present invention, a bingo game composed of tiles having the same daubing conditions for sports game results is provided to users participating in the same contest, and here, the user may move a position of at least one of tiles so that user's knowledge and analysis regarding sports game results may be utilized, and even users who do not have technical knowledge obtain good records by calculating results of a contest by reflecting the number of tiles satisfying daubing conditions with respect to the sports game results, the number of bingos achieved by these tiles, the number of tiles satisfying the daubing conditions and the number of times the tiles satisfy the daubing conditions, the number of bingos achieved by these tiles, and the number of times bingos are achieved (completed).

Further, according to the present invention, by mixing a fantasy sports game and a live bingo games, a lineup is selected, an arrangement of tiles can be changed to correspond to the lineup, and a point is provided according to a lineup registration time, whereby interest in sports game may be increased, while knowledge and efforts of users who are participating in a contest.

### DESCRIPTION OF DRAWINGS

FIG. 1 is a block diagram of an operating system for performing a sports bingo game operation method that reflects results of real-time sports data.

FIG. 2 illustrates a user interface of a sports bingo game of FIG. 1.

FIG. 3 illustrates an example of results of a bingo game.

FIG. 4 is a display screen of a bingo game generated by a controller 26.

### BEST MODES

Hereinafter, the present invention will be described in detail with reference to embodiments and drawings.

The present invention includes a method of operating a sports live bingo game and/or a fantasy sports bingo game and/or an operating system performing the method.

In addition, the sports live bingo game determines rankings of users who participate in the same contest on the basis of live points obtained from bingo games based on sports game results of a lineup selected by the users, whereas the fantasy sports bingo game determines rankings of users who participate in the same contest on the basis of fantasy points determined from lineups selected by the users and the live points of the sports live bingo games described above. The sports live bingo game and the fantasy sports bingo game may be performed simultaneously or independently and may be collectively referred to as a sports bingo game.

The present invention is also applicable to e-sports such as the league of legends (LOL), and in the present invention, sports should be recognized as a concept including traditional sports (e.g., baseball, soccer, football, etc.).

Also, the present invention may be applied to a game (e.g., a marathon) in which a plurality of gamers or gamers participate at the same time even if the game is not a sports divided into two teams. In addition, since the game is operated on the basis of real-time game data, simultaneous multi-play game (MMO) may be applied to bingo to apply fantasy sports bingo if game data is received in any form. Also, in the present invention, gamers of traditional sports and gamers of e-sports may be collectively referred to as a gamer.

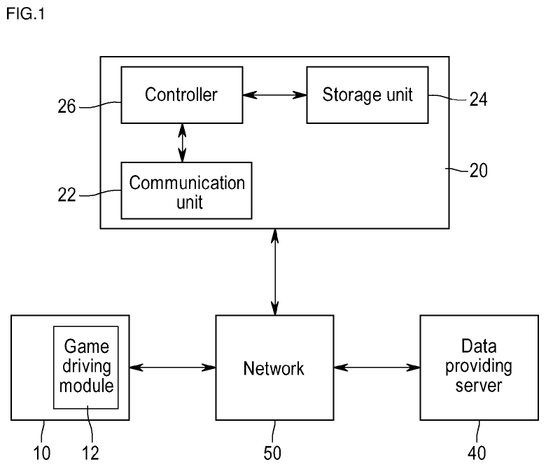

FIG. 1 is a block diagram of an operating system for performing a method of operating a sports bingo game that reflects sports game results of real-time sports data. In this disclosure, soccer is exemplarily described but the present disclosure may also be applied to any other athletic games.

The operating system includes a client terminal 10 connected to an operating server 20 via a network 50 (e.g., a wired or wireless communication network) and allowing a user to participate in a sports bingo game, an operating server 20 executing the sports live bingo game and determining results of the sports bingo game reflecting sports game results included in real-time sports data, and a data providing server 40 generating sports game information and transmitting the generated sports game information to the operating server 20 via the network 50. However, the network 50 is only a level of technology well understood by a person skilled in the art to which the present invention pertains, and thus, a detailed description thereof is omitted.

The client terminal 10 corresponds to a computing device or an information communication device (e.g., smartphone, tablet PC, etc.) including at least one data processor (e.g., a microprocessor, etc.), an input unit (e.g., a keypad, a touch pad, a voice processing input unit, etc.), a display unit (e.g., a liquid crystal display (LCD), a light emitting diode (LED), an OLED device, etc.), a communication unit, and the like, and includes a game driving module 12 for performing communication with the operating server 20, driving a sports bingo game, and the like. The game driving module 12 may be implemented by software, middleware, hardware, or the like, that drives the data processor, the input unit, the display unit, and the communication unit. The game driving module 12 displays data (e.g., a user interface screen for sports bingo game, sports game information, etc.) from the operating server 20 and transmits an input or selection from a user to the operating server 20 so that the user may be provided with a sports bingo game service.

The data providing server 40 transmits the sports game information in a row or compressed form in an XML format to the operating server 20 via the network 50.

Here, the sports game information includes league information of each sports, real-time sports data, additional information, and the like. The real-time sports game data includes team information (lineup, etc.), event information (ball occupancy, attack situation, centering, throw-in, offside, goal, and shot on target in the case of soccer, or an inning situation (on-base status, ball count), batting results, substitution information, etc., in the case of baseball), a gamer (or gamer) names (which may indicate who is involved in an event), game results of a team and gamers, and the like in the case of a baseball. Further, the sports game information includes kill, depth, assist, level, score, and the like in the case of e-sports. Further, the additional information includes team record and/or gamer (or gamer) information, and the like.

The data providing server 40 may provide the sports game information to the operating server 20 in real time or provide it after the game is terminated, for the sports bingo game service.

The operating server 20 corresponds to a computing device including a communication unit 22 for communicating with the client terminal 10 and the data providing server 40 through the network 50, a storage unit 24 storing sports game information, sports bingo game information, user information, and the like, and a controller 26 (at least one data processor (e.g., microprocessor, etc.)) generating a sports bingo game using the sports game information and storing the generated sports bingo game in sports bingo game information and determining results of the sports bingo game using real-time sports game data as the corresponding sports game is in progress. Although the operating server 20 includes the communication unit 22, the input unit (e.g., a keyboard, a touch pad, etc.) for performing an input from an operator, and a display unit (e.g., an LCD or an LED device) displaying appropriate contents, such a configuration is merely a technology naturally understood by a person skilled in the art to which the present invention pertains, and thus, a detailed description thereof is omitted.

Here, the sports game information is information received from the data providing server 40.

Also, the sports bingo game information may contest information (a type of contest, a duration of the contest, a method of paying for a contest entry fee) (e.g., cash, cards etc.) and information regarding a bingo game composed of the N×N tiles) (or grids) (here, N is a natural number of 3 or greater) in a matrix form and at least one daubing condition (including contents regarding performance results which are game results of a sports gamer and/or team) determined by the controller 26 is stored to correspond to each tile. The game results include, for example, a performance result of a sports gamer such as gamer A making three or more hits or a performance result of a sports team such as a team acquiring three or more scores, and the controller 26 generates bingo game including contents to be included in each tile and an arrangement position by using the sports game information according to a preset generation rule, and stores the bingo game in the storage unit 24.

First, the contest type includes 50/50 s (a method of equally paying for a reward to only the top 50% of the rankings), ranking (a method of paying for a reward according to a high ranking), qualifier/satellites (a method of qualifying only some of higher rankings to participate in continued contest), head to head (a method of allowing only two users to participate in a contest and paying for a reward to a winner).

A contest period corresponds to a period during which the sports bingo game is performed and is set as shown in Table 1 according to characteristics of sports events (e.g., baseball, football, soccer, basketball, etc.).

TABLE 1

| | | American | | | |
|---|---|---|---|---|---|
| Classification | Baseball | football | Soccer | Basketball | Remark |
| 1 | Time | Time | Time | Time | |
| 2 | At Bat | Turn | N/A | Turn | |
| 3 | inning | Quarter | N/A | Quarter | |
| 4 | innings | Half | Half | Half | |
| 5 | A Game | A Game | A Game | A Game | Default |
| 6 | Daily | Daily | Daily | Daily | |
| 7 | Weekly | Weekly | Weekly | Weekly | |
| 8 | Monthly | Monthly | Monthly | Monthly | |
| 9 | Season | Season | Season | Season | |

In this embodiment, the contest period corresponds to a game.

In addition, daubing conditions include a gamer daubing condition and/or a team daubing condition.

The team daubing condition includes results of each team's game performance achieved during a match of two teams (e.g., a home team, a visiting team) who competes in a contest. The team daubing conditions include a game status and a status result. The team daubing conditions are shown in Table 2 below.

TABLE 2

| Classification | Game status | Condition results (example) |
|---|---|---|
| 1 | Goal | 1 score or greater, 2 score or |
| | | greater |
| 2 | Corner kick | 3 or greater, 5 or greater |
| 3 | Free kick | 4 or greater, 6 or greater |
| 4 | Throw ins | 5 or greater, 10 or greater |
| 5 | Shot saved | 2 or greater, 5 or greater |

Next, the gamer daubing conditions include a game performance result of each gamer in the game of the contest and include a game status and a status result. The gamer daubing conditions are shown in Table 3 below.

TABLE 3

| Classification | Game status | Condition results (example) |
|---|---|---|
| 1 | Goal | 1 score or greater |
| 2 | Assist | 2 or greater |
| 3 | Shot on target | 1 or greater, 2 or greater |
| 4 | Yellow card | 0, 1 or greater |
| 5 | Red card | 0, 1 or greater |
| 6 | Corner kick | 2 or greater |
| 7 | Shot saved | 1 or greater |

Next, the user information includes a user account, an access record, a result of the bingo game (benefit or point according to success), a record of participation in the bingo game, and the like.

First, a process of performing a sports live bingo game, which is a first embodiment, among sports bingo games, will be described.

The controller 26 of the operating server 20 accesses the data providing server 40 and receives sports game information from the data providing server 40 and stores the information in the storage unit 24.

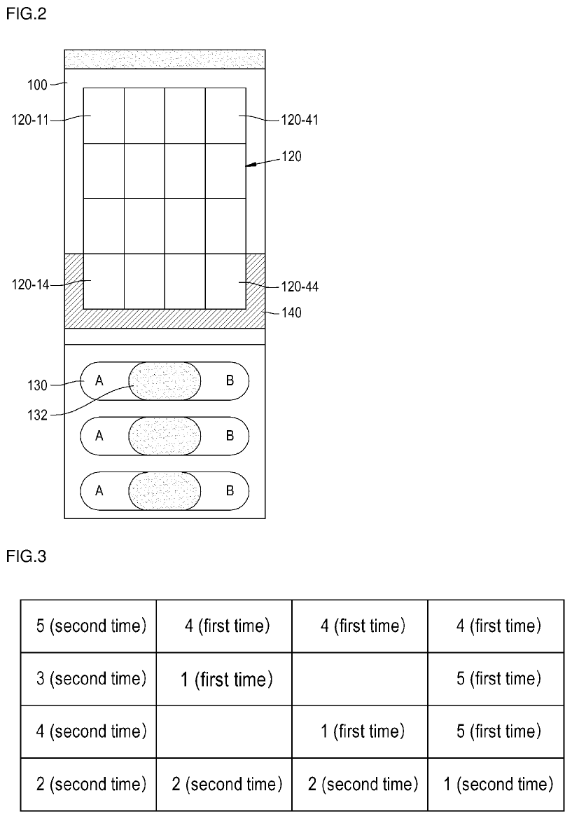

When the client terminal 10 accesses operating server 20, the controller 26 of operating server 20 reads out stored sports game information and transmits a sports type scheduled for a match and a sports game corresponding to the sports type to the client terminal 10 so that the user may select a desired contest. For this contest selection, the controller 26 transmits to the client terminal 10 a user interface that allows the user to select a desired game event, a game between desired teams, a contest type, a duration, and the like. The game driving module 12 of the client terminal 10 displays the received sports game and transmits a message including the sports game of the sports type selected by the user to the operating server 20. The controller 26 generates a contest including the user's options received from the client terminal 10 or provides the generated contest information. The contest information may include information (e.g., the number and IDs of users, etc.) of users participating in the corresponding contest. The controller 26 of the operating server 20 generates the daubing conditions for a sports bingo game of the match corresponding to the options from the client terminal 10. Here, the controller 26 generates a bingo game composed of N×N tiles (bingo game composed of 4×4 tiles in FIG. 2) on the basis of the sports game information. Here, the controller 26 generates a bingo game composed of tiles including the team daubing condition or the gamer daubing condition for teams of the selected game. The bingo game may be composed of, for example, 4 tiles (team daubing tiles) including the team daubing condition and 12 tiles (gamer daubing tiles) including the gamer daubing condition. In the first embodiment, the controller 26 may set the team daubing condition and the gamer daubing condition by an internal program and arrange the same in the 4×4 tiles or the user may set the game status and/or the status result. In addition, the controller 26 follows the daubing condition arrangement rule for specifying the number of the game status when determining the gamer daubing condition. For example, the daubing condition arrangement rule includes a plurality of conditions 1 to 3 and is shown in Table 4 below.

TABLE 4

| Position | Game status | Condition 1 | Condition 2 | Condition 3 |
|---|---|---|---|---|
| Gamer | Goal | 2 | 1 | 3 |
| | Assist | 2 | 1 | 3 |
| | Shot on Target × 1 | 2 | 2 | 0 |
| | Shot on Target × 2 | 1 | 1 | 1 |
| | Shot on Target × 3 | 1 | 0 | 2 |
| | Yellow Card | 1 | 3 | 1 |
| | Red Card | 0 | 1 | 0 |
| | Corner Kick | 2 | 2 | 1 |
| | Shot Saved | 1 | 1 | 1 |

| | | | |
|---|---|---|---|
| Total | 12 | 12 | 12 |

The controller 26 selects one of a plurality of conditions from the daubing condition arrangement rule and determines the gamer daubing condition according to the condition.

The controller 26 of operating server 20 transmits the generated bingo game (or user interface for performing the bingo game) to the client terminal 10 via the network 50.

The game driving module 12 of the client terminal 10 displays the received bingo game on the display unit and allows the user to change the arrangement of the 4×4 tiles (or the position of each tile) through the input unit. The arrangement (or position) of tiles including such a daubing condition may be changed so that various tiles may be arranged according to a strategy of each user and different results (rankings) are generated in the same contest.

Also, the controller 26 may set a specific tile (e.g., a tile including the team daubing condition) to be unchangeable in arrangement, and transmit arrangement change unavailability setting information to the client terminal 10 together. The game driving module 12 of the client terminal 10 may display the tiles, which are set to be unchangeable in arrangement, to be different from tiles which are changeable in arrangement. The game driving module 12 of the client terminal 10 obtains a tile arrangement change input through the input unit, stores the obtained tile arrangement change input, and transmits the obtained tile arrangement change input. The controller 26 of operating server 20 corrects the tile arrangement of the bingo game by reflecting the received tile arrangement change input and stores it. Through this process, the controller 26 corrects a tile arrangement of the bingo game to reflect the received tile arrangement change input and stores the corrected tile arrangement. Through this process, the controller 26 stores the bingo game corresponding to each user as sports bingo game information. The game driving module 12 may transmit a tile arrangement change input or a tile arrangement determination input (if there is no change in position of the tiles generated by the controller 26 or if an arrangement of tiles changed in position is determined) to the controller 26, and the controller 26 may store the bingo game of each user as sports bingo game information according to these inputs and may not allow the sports bingo game information to be changed afterwards.

Storing (or determining) of each user's sports bingo game information in the controller 26 of the operating server 20 described above must be completed before the start of the game of the corresponding contest (e.g., one hour before the start of the game).

The controller 26 may check whether a match corresponding to the bingo game starts upon receiving the sports game information from the data providing server 40, and after the match of the contest starts, the controller 26 determines whether a daubing condition of each tile included in the stored sports bingo game information is satisfied on the basis of the sports game information. The controller 26 flips a tile which satisfies the daubing condition or changes a state thereof (change into satisfaction) and stores the tile and transmits position information (e.g., matrix information including daubing condition satisfaction of a (2, 3) tile) regarding of the tile which satisfies the daubing condition to the client terminal 10.

The game driving module 12 of the client terminal 10 may flip a tile corresponding to the received position information regarding the tile satisfying the daubing condition or display it as state change (change into satisfaction) so that the user may check whether each tile satisfies the daubing condition in real time. For example, in a bingo game composed of 4×4 tiles, up to 16 tiles daubing condition satisfactions may be confirmed.

Further, the controller 26 receives the sports game information from the data providing server 40 at the end of the game of the contest or afterwards, and determines whether a bingo is completed, while determining whether the daubing conditions of each tile included in the user's sports bingo game information are satisfied. Whether a bingo is completed may be determined by determining whether the tiles satisfying the daubing condition are all flipped or changed in state in a line unit (e.g., four continuous tiles) horizontally/vertically/diagonally. The controller 26 transmits information including the completion of the bingo to the client terminal 10 and the game driving module 12 of the client terminal 10 receives the information and displays the bingo completion result on the display unit so that the user may check the bingo completion result in real time. For example, in a bingo game composed of 4×4 tiles, a maximum of 10 bingo completions (four horizontal lines, four vertical lines, and two diagonal lines) may be confirmed.

Further, after the match of the contest is in progress or after the game is terminated, the controller 26 adds up the number of tiles satisfying the daubing condition and the number of bingos achieved by the tiles with respect to sports game results included in real-time sports data to calculate live points of the content of each user. The controller 26 gives, for example, 1 point for each tile satisfying the daubing condition and 5 points for each bingo. For example, if a final result of a user's bingo game is 8 tiles and 2 bingos, 18 (=8+10) points are calculated as the user's contest live points. The controller 26 may transmit the calculated contest live points of each user to the client terminal 10 of each user in real time so that the user may confirm the points.

Next, the controller 26 determines rankings of the users participating in each contest on the basis of the calculated contest live points. When the contest live points is a tie, the controller 26 may determine that a ranking of a user having a large number of bingos is higher.

Next, the controller 26 determines a reward target according to a reward method of the contest, proceeds a reward to users as the determined reward targets, stores reward contents (e.g., cash, game points, event tickets, etc.) as information of the users which are reward targets, and transmits the reward contents to the client terminal 10 of each user to notify about the reward contents.

As described above, the operating server 20 generates at least one contest in which a plurality of users compete in a sports live bingo game, and carries out a sports live bingo game in each contest. Further, the operating server 20 allows users to select positions of the tiles included in the bingo game on the basis of a skill and knowledge of the users to quickly complete a bingo among a large number of users having the same sports live bingo game information.

FIG. 2 illustrates a user interface of the sports bingo game of FIG. 1.

A user interface 11 is displayed on the display unit by the game driving module 12 of the client terminal 10 and includes a first information providing UNIT 11-1 displaying a game progress situation (e.g., a score, a game progress time, etc.), a bingo game providing unit 11-2 displaying a bingo game, and a second information providing unit 11-3 for providing game information.

The first information providing unit 11-1 displays a game progress status including game teams, a score, a game progress time, etc., of the contest, the operating server 20 receives sports game information from the data providing server 40 in real time and transmits the received sports game information to the client terminal 10, and the game driving module 12 of the client terminal 10 displays the game progress status in the received sports game information on the first information providing unit 11-1.

The bingo game providing unit 11-2 displays a bingo game composed of 4×4 tiles including the daubing conditions included in the sports bingo game information received from operating server 20. The bingo game is composed of 16 tiles B11 to B44, and a corresponding daubing condition is displayed in each tile. A tile satisfying the daubing condition is displayed in a blue color, indicating a changed state of the tile, so that the user may check it.

The third information providing unit 11-3 receives the sports game information from the data providing server 40 in real time and displays the game information (e.g., game status such as file, throw-in, etc.) of the sports game information transmitted to the client terminal 10 so that the user may check the game information in real time even if the user does not use a separate medium.

As another embodiment, there are described examples that apply to LOL such as league of legends which is e-sports among sports.

The contest information (type and duration of the contest) included in the sports bingo game information is applied in the same manner as described above.

In this embodiment, the contest duration corresponds to one game.

In addition, the daubing condition includes a team daubing condition and a gamer daubing condition.

The team daubing condition includes a game performance result of each team achieved in the game of two teams (e.g., a home team and a visiting team) playing a match in the game of the contest, and the team daubing condition includes a game status and a status result. The team daubing conditions are shown in Table 5 below.

TABLE 5

| Classification | Condition | Expected occurrence time |
|---|---|---|
| 1 | Win | End of game |
| 2 | Lose | End of game |
| 3 | First kill) | Early in game |
| 4 | First death | Early in game |
| 5 | First assist | Early in game |
| 6 | Success in baron kill | Middle/later stage in game |
| 7 | Success in first dragon kill | Early/middle stage in game |
| 8 | Win by double score | End of game |
| 9 | First tower | Early/middle stage in game |
| 10 | First inhibitor | Middle/later stage in game |

Next, the gamer daubing condition includes a game performance result of each gamer in the game of the contest, and includes a game status and a status result. The gamer daubing conditions are shown in Table 6 below.

TABLE 6

| Classification | Condition | Expected occurrence time |
|---|---|---|
| 1 | First kill | Early in game |
| 2 | Second kill | Early in game |
| 3 | First death | Early in game |
| 4 | First assist | Early in game |
| 5 | Last kill | End of game |
| 6 | Last death | End of game |
| 7 | Last assist | End of game |
| 8 | Assist 0 (zero) | End of game |
| 9 | Achieve 18 level first | Middle stage in game |
| 10 | Success in double kill | Unpredictable |
| 11 | Success in double kill | Early in game |
| | before 6 level | |
| 12 | Success in triple kill | Unpredictable |
| 13 | Success in triple kill | Early in game |
| | before 6 level | |
| 14 | Success in quadruple kill | Unpredictable |
| 15 | Success in penta kill | Unpredictable |
| 16 | Arrive at CS 250 | Later stage in game |
| 17 | Sum of K/D/A is 20 or | End of game |
| | greater | |
| 18 | Depth two or more times | End of game |
| | before 6 level | |

Next, the user information includes a user account, an access record, a result of a bingo game (benefit or point according to success), a participation record of a bingo game, and the like.

A process of performing a sports bingo game is described.

The controller 26 of operating server 20 receives the sports game information from the data providing server 40 and generates sports bingo game information.

When the client terminal 10 accesses operating server 20, the controller 26 of operating server 20 transmits the sports bingo game information regarding the game scheduled for the match to the client terminal 10 so that the user may select a desired contest. For this contest selection, the controller 26 transmits to the client terminal 10 a user interface that allows the user to select a desired sports event or game, a game between desired teams, a contest type, a duration, and the like. The controller 26 generates a contest including user's options received from the client terminal 10 or provides previously generated contest information. The contest information may include information of users participating in the corresponding contest (e.g., the number or IDs of users, etc.).

The controller 26 of the operating server 20 generates daubing conditions for the sports bingo game of the match corresponding to the options from the client terminal 10. Here, the controller 26 generates a bingo game composed of N×N tiles (a bingo game composed of 4×4 tiles in FIGS. 2 and 3) in a matrix form on the basis of the sports game information. Here, the controller 26 generates a bingo game composed of tiles including a gamer daubing condition and/or a team daubing condition for the teams of a selected game. The bingo game may be composed of, for example, four tiles (team daubing tiles) including a team daubing condition and 12 tiles (gamer daubing tile) including a gamer daubing condition. In the present embodiment, the controller 26 may set the team daubing condition and the gamer daubing condition by an internal program and place the team daubing condition and the gamer daubing condition in 4×4 tiles or may allow the user to set a game status and/or a status result. In addition, the controller 26 follows a daubing condition arrangement rule for specifying the number of each game status when determining the gamer daubing condition.

The controller 26 selects one of a plurality of conditions in the daubing condition arrangement rule and determines a gamer daubing condition according to the selected condition.

The controller 26 of operating server 20 transmits the generated bingo game (or a user interface for performing the bingo game) to the client terminal 10 through the network 50.

The game driving module 12 of the client terminal 10 displays the received bingo game on the display unit and allows the user to change the arrangement of the 4×4 tiles (or the position of each tile) through the input unit. Since it is possible to change the arrangement (or position) of the tiles including the daubing conditions, each user may variously arrange tiles according to a strategy for each user, and thus, different results are generated in the same contest.

Also, the controller 26 may set such that it is not possible to change the arrangement of a specific tile (e.g., a tile including the team daubing condition), and arrangement change unavailability setting information to the client terminal 10 together. The game driving module 12 of the client terminal 10 may display tiles, which are set to be unchangeable in arrangement, to be different from the tiles which are changeable in arrangement. The game driving module 12 of the client terminal 10 obtains and stores a tile arrangement change input through the input unit and transmits the obtained tile arrangement change input to the operating server 20. The controller 26 of the operating server 20 corrects a tile arrangement of the bingo game to reflect the tile arrangement change input and stores the corrected tile arrangement. Through this process, the controller 26 stores the bingo game corresponding to each user as sports bingo game information.

Storing (or determining) the sports bingo game information of each user in the controller 26 of the operating server 20 described above must be completed before the start of the game of the corresponding contest (e.g., one hour before the start of the game).

When the sports game information is received from the data providing server 40, the controller 26 may determine that the match corresponding to the bingo game generated by the user has been started. After the game of the contest is started, the controller 26 determines whether the daubing conditions of each tile included in the stored sports bingo game information are satisfied with respect to the sports game information. The controller 26 flips a tile satisfying the daubing condition or changes a state thereof (change into satisfaction) and stores it. The controller 26 transmits position information regarding the tile satisfying the daubing condition (e.g., matrix information including daubing condition satisfaction of (2,3) tile) to the client terminal 10, and the game driving module 12 of the client terminal 10 displays the flipping of the tile or change in state (change to satisfaction) corresponding to the received position information regarding the tile satisfying the daubing condition so that the user may check whether each tile satisfies the daubing condition in real time. For example, in a bingo game composed of 4×4 tiles, daubing condition satisfactions of up to 16 tiles may be checked. Also, the controller may limit the number of times each tile satisfies the daubing condition to a single number, but in this disclosure, the daubing conditions of each tile may be satisfied a plurality of times and the number of times each tile satisfies the daubing condition may be limited to, for example, 3 times. Also, the controller 26 may set the number of times the tile, to which the gamer daubing condition is given, satisfies the daubing condition and the number of times the tile, to which the team daubing condition is given, satisfies the daubing condition, to be different from each other. For example, the number of times the tile to which the gamer daubing condition is given satisfies the daubing condition may be set to be plural and the number of times the tile to which the team daubing condition is given may be set to be a single number (i.e., one time). Further, the controller 26 may set daubing scores of the respective tiles to be the same or to be different from each other.

Further, by receiving the sports game information from the data providing server 40 at the end of the game of the contest or afterwards, the controller 26 determines whether a bingo is completed by determining whether the daubing conditions of each tile included in the user's sports bingo game information are satisfied. Whether a bingo is completed may be determined by determining whether the tiles satisfying the daubing conditions are all flipped or changed in state in units of lines (e.g., four continuous lines) horizontally/vertically/diagonally. The controller 26 transmits information including whether or not the bingo is completed to the client terminal 10. The game driving module 12 of the client terminal 10 receives the above information and displays the bingo completion result on the display unit so that the user may check the bingo completion result in real time. For example, in the bingo game composed of 4×4 tiles, a bingo completion in the form of a maximum of 10 lines (4 horizontal lines, 4 vertical lines, 2 diagonal lines) may be confirmed. Further, in this embodiment, since the number of times each tile satisfies the daubing conditions may be made a plurality of times, and since the number of times each tile satisfies the daubing condition is limited, a plurality of bingo may be completed even in the form of ten bingo lines and the number of times bingos are completed is also limited.

Also, the controller 26 may set a bingo score regardless of the form of the bingo line or may additionally add weight to the bingo score according to the form of the bingo line. First, in the case where the bingo score is set irrespective of the form of the bingo line, the controller 26 gives a bingo score of 5 points per bingo or gives 20 points to a first bingo and additionally gives 5 points each time, starting from the second bingo to set or calculate the bingo score. Next, in the case where a weight is given to the bingo score according to the form of a bingo line, a score obtained by multiplying a weight for each bingo line (e.g., 0.8 for horizontal line and vertical line and 1.2 for diagonal line) to the sum of daubing scores of four tiles completed as each bingo may be set or calculated as a bingo score, and here, when each bingo is completed a plurality of times, the number of times the bingos are completed may be additionally multiplied to set or calculate the bingo score.

In addition, in the process of the game of each contest or after the game is terminated, points of the contest of each user are calculated by reflecting the number of times daubing conditions are satisfied and/or the number of times bingos are completed with respect to sports results included in real-time sports data.

A first point calculation method is shown in Table 7:

TABLE 7

| | |
|---|---|
| Total daubing score | Sum of (daubing score of each tile |
| | satisfying daubing condition × |
| | number of times each tile satisfies |
| | daubing condition) |
| Total bingo score | Sum of (Score per bingo × number |
| | of times each bingo is completed) |
| Points of contest | Total daubing score + total bingo score |

In the first point calculation method, the number of times each tile satisfies the daubing conditions may be a plurality of times, the number of times each bingo is completed may be a plurality of times, and the same score (e.g., 3 points) is given to completion of each bingo.

FIG. 3 is an example of a result of a bingo game, and points of the contest according to the first point calculation method are as shown in Table 8:

TABLE 8

| | |
|---|---|
| Total daubing score | 5 × 2 + 4 × 1 + 4 × 1 + 4 × 1 + 3 × 2 + 1 × 1 + |
| | 5 × 1 + 4 × 2 + 1 × 1 + 5 × 1 + 2 × 2 + 2 × 2 + |
| | 2 × 2 + 1 × 2 = 62 |
| Total bingo score | Bingo score of first column (3 × 2) + bingo |
| | score of fourth column (3 × 1) + bingo score |
| | of first row (3 × 1) + bingo score of fourth row |
| | (3 × 2) + bingo score of diagonal line (3 × 1) = 21 |
| Points of contest | Total daubing score + total bingo score = 83 |

A second point calculation method is shown in Table 9:

TABLE 9

| | |
|---|---|
| Total daubing score | Sum of (daubing score of each tile satisfying |
| | daubing condition × number of times each |
| | tile satisfies daubing condition) |
| Total bingo score | Sum of (sum of daubing scores of tiles |
| | completed by each bingo × weight of each |
| | bingo line) |
| Points of contest | Total daubing score + total bingo score |

In the second point calculating method, the number of times each tile satisfies the daubing conditions may be a plurality of times, and a weight for each bingo line is applied.

FIG. 3 shows an example of the result of a bingo game, and points of the contest according to the second point calculation method are as shown in Table 10:

TABLE 10

| | |
|---|---|
| Total daubing score | 5 × 2 + 4 × 1 + 4 × 1 + 4 × 1 + 3 × 2 + |
| | 1 × 1 + 5 × 1 + 4 × 2 + 1 × 1 + 5 × 1 + |
| | 2 × 2 + 2 × 2 + 2 × 2 + 1 × 2 = 62 |
| Total bingo score | Bingo score of first column (28 × 0.8) + |
| | bingo score of fourth column (16 × 0.8) + |
| | bingo score of first row (22 × 0.8) + |
| | bingo score of fourth row (14 × 0.8) + |
| | bingo score of diagonal line (14 × 1.2) = 80 |
| Points of contest | Total daubing score + total bingo score = 142 |

For example, the weights for bingo lines are applied horizontally/vertically (0.8) and diagonally (1.2).

A third point calculation method is shown in Table 11:

TABLE 11

| | |
|---|---|
| Total daubing score | Sum of (daubing score of each tile |
| | satisfying daubing condition × |
| | number of times each tile satisfies |
| | daubing condition) |
| Total bingo score | Sum of (sum of daubing scores of four |
| | tiles completed by each bingo × number |
| | of times bingo is completed × weight |
| | of each bingo line) |
| Points of contest | Total daubing score + total bingo score |

In the third point calculation method, the number of times each tile satisfies the daubing conditions may be a plurality of times, a weight for bingo line is applied, and only a daubing score of four tiles in which each bingo is completed is included in a total bingo score.

FIG. 3 is an example of the result of a bingo game, and points of the contest according to the third point calculation method are as shown in Table 12:

TABLE 12

| | |
|---|---|
| Total daubing score | 5 × 2 + 4 × 1 + 4 × 1 + 4 × 1 + 3 × 2 + |
| | 1 × 1 + 5 × 1 + 4 × 2 + 1 × 1 + 5 × 1 + |
| | 2 × 2 + 2 × 2 + 2 × 2 + 1 × 2 = 62 |
| Total bingo score | Bingo score of first column (14 × 2 × 0.8) + |
| | bingo score of fourth column (15 × 1 × 0.8) + |
| | bingo score of first row (17 × 1 × 0.8) + |
| | bingo score of fourth row (7 × 2 × 0.8) + |
| | bingo score of diagonal line (8 × 1.2) = 68.8 |
| Points of contest | Total daubing score + total bingo score = 130.8 |

In the embodiment of FIG. 3, a first column corresponds to two times of bingo, a fourth column corresponds to one time of bingo, a first row corresponds to one time of bingo, and a fourth row corresponds to two time of bingo. When a total bingo score is calculated, only the sum of the daubing scores of four tiles configuring one time of bingo is used in the third point calculation method.

When a daubing score of tiles including gamer daubing condition in the total daubing score is calculated by applying one of the first to third point calculation methods, the controller 26 considers points of each gamer corresponding to K (KILL)/D (DEATH)/A (ASSIST) index. The points for each gamer is set to (K×1.5+D×0.8+A×1.3), for example. The controller 26 calculates points of each gamer on the basis of K (KILL)/D (DEATH)/A (ASSIST) index for each gamer, and uses the points of each gamer at the time of calculating a total daubing score when points of the contest are calculated according to one of the first to third point calculation methods.

The controller 26 transmits the calculated contest points of each user to the client terminal 10 of each user in real time so that the user may check the contest points.

Next, the controller 26 determines rankings of the users participating in each contest on the basis of the calculated contest points. When the contest points are a tie, the controller 26 may determine that a ranking of a user having a large number of bingos is higher.

Next, the controller 26 determines a reward target according to a reward method of the contest, proceeds a reward to users as the determined reward targets, stores reward contents (e.g., cash, game points, event tickets, etc.) as information of the users which are reward targets, and transmits the reward contents to the client terminal 10 of each user to notify about the reward contents.

In another embodiment related to a fantasy sports bingo game, each grid provides a bingo game that includes a plurality of daubing conditions, and contest points of the bingo game is calculated in association with a fantasy sports game.

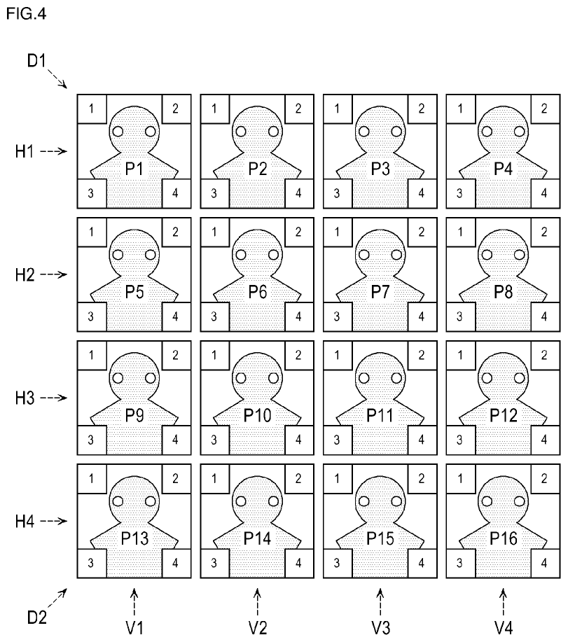

FIG. 4 is a display screen of a bingo game generated by the controller 26. The bingo game generated by the controller 26 is composed of N×N (N=4 in FIG. 4 and N is a natural number of 3 or greater) tiles (tile ID: P1 to P16) in a matrix form, and each of the tiles P1 to P16 includes at least two or more daubing conditions (four in FIG. 4). Each daubing condition is related to a game performance or results of gamers included in a lineup of the contest selected by the user or a team related to the contest.

The daubing conditions are shown in Table 13 below.

TABLE 13

| Condition | Condition contents (Baseball) | Condition contents (Soccer) |
|---|---|---|
| 1 | Hit (1base, 2base, 3base) | Shoot (shot on target) |
| 2 | Score (Run, Home Run) | Offensive point (goal, assist) |
| 3 | Infield out (ground out) | Pass (successful pass) |
| | (ground putout, putout | |
| | assist, strike out) | |
| 4 | Outfield out (fly putout) | Foul (cards) |

As described above, the conditions 1 to 4 correspond to gamer tiles and include the condition contents related to game performance or results of each gamer. When the game performance or results of the conditions 1 to 4 are generated, the controller 26 determines that the conditions 1 to 4 are satisfied.

Team tiles are also configured as shown in Table 14, similar to the gamer tiles:

TABLE 14

| Condition | Condition contents (e-sports) | Condition contents (Soccer) |
|---|---|---|
| 1 | First kill | Earn score |
| 2 | Tower | Lose point |
| 3 | Dragon | change |
| 4 | Inhibitor | Foul |

As described above, the conditions 1 to 4 correspond to team tiles and include the condition contents related to game performance or the results of each team. When the game performance or results of the conditions 1 to 4 are generated, the controller 26 determines that the conditions 1 to 4 are satisfied, that is, daubed.

Each of the daubing conditions includes independent condition contents.

Alternatively, each of the daubing conditions may be independent of each other and correspond to different condition arrangement positions. When the condition arrangement positions are difference between a plurality of tiles having the same daubing conditions of the same gamer such as spatial positions such as upper left (condition 1), upper right (condition 2), lower left (condition 3) and lower right (condition 4) or positions in order such as first (condition 1), second (condition 2), third (condition 3), and fourth (condition 4), the plurality of tiles are distinguished from each other. That is, the condition arrangement positions correspond to positions where a plurality of tiles are distinguished from each other. The daubing conditions (conditions 1 to 4) may be different from each other or may be overlapping conditions.

When generating a bingo game for users participating in the same contest, the controller 26 allows gamers or a team included in a lineup to have the same condition content and condition arrangement position. Alternatively, the controller 26 may vary the respective condition arrangement positions of the condition 1 to the condition 4 included in gamer tiles and/or team tiles so that the condition 1 to the condition 4 have the condition arrangement positions selected by the users. For example, it is possible to configure condition arrangement positions of the upper left (condition 3), upper right (condition 2), lower left (condition 1) and lower right (condition 4). In addition, for convenience of the users, when the game driving module 12 obtains a command for changing the condition arrangement position from the user and transmits the command to operating server 20, the controller 26 may change the condition arrangement position by rotating the respective positions (spatial positions or positions in order, etc.) of the conditions 1 to 4 according to the received command for changing the condition arrangement positions. Further, in the case of team tiles, the controller 26 may arbitrarily select the positions of the conditions 1 to 4 and include them in the user's bingo game.

Also, the controller 26 allows the user to change the arrangement position of each tile (row and column which are the positions of each tile), as in the embodiment described above.

As described above, the controller 26 generates a bingo game composed of tiles including a plurality of daubing conditions, and a tile generation rule may be described as follows:

1. First rule: Tiles including a plurality of daubing conditions (when there is no condition arrangement position) or

2. Second rule: Tiles including a plurality of daubing conditions and condition arrangement positions corresponding to each of the daubing conditions.

Next, a process of determining whether a bingo is completed will be described.

First, a case of tiles to which the first rule is applied will be described. Since each tile has only a plurality of daubing conditions, the controller 26 considers only the result of each condition when determining whether or not the bingo is completed. That is, when performance results of condition contents are the same in tiles of line units which are directions of horizontal lines H1 to H4/vertical lines V1 to V4/diagonal lines D1 and D2, the controller 26 determines that a bingo is completed. Therefore, a number of bingos corresponding to at least the number of condition contents within the tiles of a line unit in the same direction. That is, bingos may be completed in an overlapping manner with the same condition contents (daubing condition) in the tiles of the same line unit.

For example, in FIG. 4, if the game performance (e.g., one or one point) which are daubing conditions in the tiles P1, P6, P11, and P16 in the diagonal direction D1 is the same, the controller 26 determines that one bingo is completed. Therefore, since there are four bingo conditions exist in the tiles P1, P6, P11, and P16 in the diagonal direction D1, there are four bingos. Further, if game performance which is bingo conditions in the tiles P1, P6, P11, and P16 in the diagonal direction D1 are two or two scores, for example, the controller 26 calculates that two bingos are completed.

Next, a case of tiles to which the second rule is applied will be described. Since each tile has a plurality of daubing conditions and a plurality of condition arrangement positions, the controller 26 considers both game results of each condition and the condition arrangement position when determining whether or not a bingo is completed. That is, when game results which are the condition contents positioned at the same condition arrangement position in the tiles of a line unit (e.g., four successive tiles) which is in the horizontal lines H1 to H4/vertical lines V1 to V4/diagonal lines D1 and D2 are the same, the controller 26 determines that a bingo is completed. Therefore, each bingo may be completed in a bingo direction corresponding to at least the number of the condition arrangement positions in the tiles of the line unit in the same direction. In addition, bingos may be completed in the bingo direction corresponding to the number of the condition arrangement positions in the tiles of the line unit in the same direction.

For example, in FIG. 4, if game performance (e.g., 1 or 1 score) at the upper left position among the condition arrangement positions in the tiles P1, P6, P11, and P16 in the diagonal direction D1, the controller 26 determines that one bingo is completed. Therefore, since there are four condition arrangement positions in the tiles P1, P6, P11 and P16 in the diagonal direction D1, four bingo directions (upper left position bingo, upper right position bingo, lower left position bingo, and lower right position bingo) exist. In addition, when game performance at the upper left position in the tiles P1, P6, P11, and P16 in the diagonal direction D1 is two or two scores, for example, the controller 26 calculates that two bingos are completed.

Next, a process of calculating a contest point on the basis of a completed bingo will be described, and the contest point is based on a fantasy point of a fantasy sports game. The fantasy point calculated in the process of a contest will be described hereinafter.

In addition, a rule for calculating fantasy points of gamers included in a lineup applied to a contest is shown in Table 15:

TABLE 15

| Position | List | FP Base |
|---|---|---|
| Pitcher | Inning Pitched | 2.25 |
| | Strike Out | 2 |
| | Win | 4 |
| | Earned Run Allowed | −2 |
| | Hit Against | −0.6 |
| | Base on Balls Against | −0.6 |
| | Hit Batsman | −0.6 |
| | Complete Game | 2.5 |
| | Complete Game Shut Out | 2.5 |
| | No Hitter | 5 |
| Hitter | Single | 3 |
| | Double | 5 |
| | Triple | 8 |
| | Home Run | 10 |
| | Run Batted In | 2 |
| | Hit By Pitch | 2 |
| | Base on Balls | 2 |
| | Run | 2 |
| | Stolen Base | 5 |

The controller 26 receives the sports game information in real time from the data providing server 40, calculates fantasy points of the gamers included in the lineup according to the fantasy point rule of Table 15, and stores the respective fantasy points obtained by the gamers. The controller 26 transmits the calculated fantasy points to the client terminal 10 and the game driving module 12 of the client terminal 10 displays the received fantasy point on the user interface together. Since the fantasy point FP1 is calculated in the same manner as that of a fantasy sports game of a related art, it is obvious to those skilled in the art to which the present invention pertains, and thus, a description thereof will be omitted.

In addition, the controller 26 may calculate a fantasy point, which is a game result for each gamer included in the lineup of each user. A criterion for calculating fantasy points in e-sports may be set as a criterion considering game characteristics of each e-sports. Table 16 below is an example of a fantasy point rule in a battle ground.

TABLE 16

| Clause | Kind (Meaning) | FP BASE |
|---|---|---|
| Movement | Cumulative movement | +1 point (proportional to |
| | distance | accumulated movement |
| | | distance) |
| Item | Item is obtained | +1 point (proportional to |
| | | the number of items) |
| Damage | Cumulative damage of own | −1 point (proportional to |
| | so far | accumulated damage) |
| Attack | Cumulative damage value | +1 point (proportional to |
| | against opponent | accumulated damage value) |
| Kill | Number of achievement of | +1 point (proportional to the |
| | kill | number of achievement of kill) |
| death | death | −1 point |
| faint | Knock opponent out | +1 point |
| | Knocked himself out | −1 point |
| | Recover our ally who is | +1 point (proportional to the |
| | knocked out | number of recovered allies) |

The controller 26 receives sports game information in real time from the data providing server 40, calculates game performance (results) of each gamer included in the lineup as fantasy points in real time according to the fantasy point rule of Table 16, and stores the fantasy points obtained by each gamer.

As described above, the controller 26 calculates the fantasy point of a corresponding gamer in the case of a gamer tile, but does not apply the fantasy point to a team tile.

Next, the controller 26 determines whether or not the daubing conditions of each tile are achieved according to the sports game information received in real time, calculates fantasy points of a gamer of tiles in which the daubing condition is achieved, as daubing points and stores the daubing points. As for a daubing point of a tile which has been daubed but has not completed a bingo, the controller 26 may add up the daubing point to a contest point when determining a ranking although the daubing point has not contributed to completion of a bingo as described hereinafter.

Also, the controller 26 determines whether or not a bingo is completed together, while determining whether or not the daubing conditions of each tile are achieved. When the bingo is completed, the controller 26 adds up the fantasy points obtained by the garners corresponding to the tiles completing the bingo and stores the fantasy points as bingo points. However, not all of the fantasy points obtained by the garners are added up but fantasy points are added up to a time when the daubing conditions contributing to the completion of the bingo are satisfied. For example, when game performance (e.g., one or one score) which is conditions at the upper left position among the condition arrangement positions in the tiles P1, P6, P11, and P16 in the diagonal direction D1 are the same, the controller 26 determines that one bingo is completed, and adds up the fantasy points until the bingo conditions are satisfied when the bingo is completed. In this case, since all of the game performance, which is daubing conditions, is equally satisfied, the controller 26 adds up the fantasy points obtained by the garners corresponding to each tile. If game performance of the tile P1 is two and game performance of the other tiles P6, P11 and P16 is one, the controller 26 adds up a fantasy point obtained until a garner corresponding to the tile P1 achieves one game performance and fantasy points obtained by garners corresponding to the other tiles P6, P11, and P16 until the daubing conditions are satisfied. In addition, even if bingos are completed in an overlapping manner, the controller 26 adds up the fantasy points obtained by the garners when the bingos are completed in the overlapping manner.

The team tile is only daubed when daubing conditions included in the team tile are satisfied or achieved. The team tile is related only to the completion of a bingo in the bingo direction, and the controller 26 does not apply a separate fantasy point to the team tile. Therefore, when calculating a bingo point, the controller 26 adds up only the fantasy points of the garners of the garner tile.

When the bingo points are calculated, the controller 26 may apply a weight according to the horizontal lines H1 to H4/vertical lines V1 to V4/diagonal lines D1 and D2 (i.e., bingo directions) which are direction in which a bingo is completed. That is, the controller 26 may calculate bingo points by multiplying the summed fantasy points by different weights according to the bingo directions and stores the calculated bingo points. The controller 26 may apply the weights shown in Table 17.

TABLE 17

| Bingo direction (line unit) | Weight |
|---|---|
| Horizontal line (H1) | 2.1 |
| Horizontal line (H2) | 2.2 |
| Horizontal line (H3) | 2.3 |
| Horizontal line (H4) | 2.2 |
| Vertical line (V1) | 2.1 |
| Vertical line (V2) | 2.2 |
| Vertical line (V3) | 2.3 |
| Vertical line (V4) | 2.4 |
| Diagonal line (D1) | 2.5 |
| Diagonal line (D2) | 2.5 |

Since the weights according to the bingo directions are different as shown in Table 17, even if bingos are completed under the same daubing conditions, the bingo points are different according to the directions of the bingos. The controller 26 stores weight information regarding the bingo directions.

The controller 26 generates contest information for at least one game (e.g., game between soccer team A and team B), determines a contest lineup (entry) registration completion time, and provides the contest information and the contest lineup registration completion time to the client terminal 10. The game driving module 12 displays the provided contest information and the contest lineup registration completion time to the user, and the user checks the contest information, determines a lineup, and transmits the determined lineup to operating server 20. The controller 26 calculates a time (contest information disclosure time) at which the client terminal 10 may access to receive the contest information and a time (lineup determination time) at which the finally determined lineup is received from the client terminal 10 and stores the calculated time. The controller 26 reflects a time difference between the lineup determination time and the contest information disclosure time or a time difference (remaining time of lineup registration completion) between the contest lineup registration completion time and the lineup determination time in the contest point. In other words, this is intended to give a contest point to the user who determined the lineup more rapidly. For example, the controller 26 converts the remaining time of lineup registration completion into seconds, and adds up a contest point of 0.01 per 10 seconds to a contest point of each user. That is, the contest point is calculated to be higher as the time required for determining the lineup is shorter, and the contest point is calculated to be higher as the remaining time of the lineup registration completion is longer. The controller 26 calculates a contest point (time point) related to the lineup determination time and stores the same.

Further, the controller 26 generates a bingo game including a gamer tile included in a lineup completed in registration by each user and/or a team tile (arrangement information of each tile) of a game of a contest target, daubing conditions of each tile, condition arrangement positions of daubing conditions, and the like and stores the generated bingo game. In addition, the controller 26 transmits the generated bingo game to the client terminal 10. The game driving module 12 displays the received bingo game, receives a user change command regarding a change in arrangement of a tile, a condition arrangement position of a daubing condition, and the like from the input unit, and transmits the received user change command to the operating server 20. In addition, the controller 26 updates the bingo game of the user according to the received user change command.

When a target sports event is started, the controller 26 calculates the bingo points as described above, according to the sports game information received from the data providing server 40.

When the sports event of the contest target is terminated, the controller 26 calculates rankings of the users participating in each contest, and the rankings are calculated by adding up the points of Equation 1 as follows.

Contest point=fantasy points of gamers included in lineup+final bingo points+time point+final daubing points [Equation 1]

First, the fantasy points of the gamers included in the lineup are included in the contest points regardless of whether a bingo is completed, so that the fantasy points of the gamers included in the entry selected by the user based on the knowledge and efforts of the user affect the contest points.

Second, points based on completion of a bingo in association with arrangement of tiles selected by the user based on knowledge and efforts of the user are reflected in the contest points.

Third, the time point is a point calculated to be higher as the user quickly completes contest registration by his or her efforts.

Fourth, the final daubing points are the sum of fantasy points obtained by the gamer of the tile which has achieved the daubing condition of the tile corresponding to the gamer included in the lineup by the user but has not contributed to the completion of the bingo.

The controller 26 may calculate the contest point in real time and transmit it to the client terminal 10. In addition, the controller 26 may transmit the ranking in the contest to the client terminal 10 in real time.

Next, the controller 26 determines the rankings of the users participating in each contest on the basis of the calculated contest points. When the contest points are a tie, the controller 26 may determine that a ranking of a user having a larger number of bingos is higher.

In addition, the controller 26 may determine the ranking of the contest on the basis of the sum of one point among the final bingo points or the time point described above and the fantasy points of the gamers included in the lineup.

Next, the controller 26 determines a reward target according to a reward method of the contest, proceeds a reward to users as the determined reward targets, stores reward contents (e.g., cash, game points, event tickets, etc.) as information of the users which are reward targets, and transmits the reward contents to the client terminal 10 of each user to notify about the reward contents.

The client terminal 10 may install an application APP for performing the sports live bingo game or the fantasy sports bingo game described above by downloading it from the operating server 20 or 200 which performs downloading and upgrading of an application. In addition, the program for carrying out the sports live bingo game or the fantasy sports bingo game of the present invention may be provided in the form of a storage medium (e.g., a state stored in a storage) for storing a computer-readable program, in addition to the above-described application form, and the computer-readable program is executed by a data processor of the operating server. The sports live bingo game and the fantasy sports bingo game described above may be collectively referred to as a sports bingo game.

Various implementations of the subject matter described herein may be implemented with digital electronic circuits, integrated circuits, specifically designed application specific integrated circuits (ASICs), computer hardware, firmware, software, and/or combinations thereof. These various implementations may include implementation in one or more computer programs which can be executable and/or interpretable on a programmable system including at least one dedicated or universal programmable processor which is coupled to receive data and instructions from a storage system, at least one input device, and at least one output device, and to transmit data and instructions thereto.

These computer programs (also known as programs, software, software applications, or code) include machine instructions for a programmable processor and may be implemented in an advanced procedural and/or object oriented programming language and/or assembly language/machine language. As used herein, the term of machine-readable medium refers to a certain computer program article, apparatus, and/or device (e.g., magnetic disk, optical disk, memory, programmable logic device (PLD)) used to provide machine instructions and/or data to a programmable processor, including machine-readable medium for receiving machine instructions as a machine-readable signal.

The subject matter (e.g., as a data server) described herein may include a back-end component, a middleware component (e.g., an application server), a front-end component (e.g., a client computer having a graphic user interface or a web browser capable of interacting with implementation of the subject matter described herein) or may be implemented in a computing system including any combination of a back-end, middleware, or front-end component. The components of the system may be interconnected by any form or medium of digital data communication (e.g., a communication network). Examples of communication networks include a local area network (LAN), a wide area network (WAN), and the Internet.

As described above, the present invention is not limited to the specific embodiments. Thus, it will be understood by those skilled in the art that a variety of modifications and variations may be made to the present invention without departing from the spirit or scope of the present invention defined in the appended claims.

1: A sports bingo game operation method implemented by at least one data processor provided in a computing device capable of communicating with a client terminal of each user, the sports bingo game operation method comprising:
generating, by the data processor, a bingo game of each user including at least N×N (N is a natural number of 3 or greater) tiles related to a sports game performance;
determining, by the data processor, whether each of the tiles is daubed and the daubed tiles complete a bingo according to the sports game information according to sports game information; and
determining a ranking of each user on the basis of points related to the daubed tiles and points related to the completed bingo.

2: The sports bingo game operation method of claim 1, wherein the tiles of the bingo game comprise a sports team, performance of the sports team or a gamer and performance of the gamer as daubing conditions.

3: The sports bingo game operation method of claim 2, wherein the data processor determines daubing conditions of each tile according to one condition of a predetermined daubing condition arrangement rule.

4: The sports bingo game operation method of claim 1, further comprising:
changing, by the data processor, an arrangement position of at least two or more tiles according to a movement command to update the bingo game,
wherein the determining may include determining whether each of the tiles is daubed for the updated bingo game and whether the daubed tiles complete bingo.

5: The sports bingo game operation method of claim 4, wherein the updating of the bingo game comprises changing, by the data processor, an arrangement position of daubing conditions of at least two tiles according to the movement command.

6: The sports bingo game operation method of claim 1, wherein the points related to the daubed tiles are related to the number of the daubed tiles.

7: The sports bingo game operation method of claim 1, wherein the points related to the completed bingo are related to the number of the completed bingo.

8: The sports bingo game operation method of claim 1, wherein each time is daubed a plurality of times.

9: The sports bingo game operation method of claim 8, wherein the points related to the daubed tiles are related to the number of the daubed tiles and the number of times the tiles are daubed.

10: The sports bingo game operation method of claim 8, wherein the times daubed a plurality of times complete bingos a plurality of times in the same bingo direction.

11: The sports bingo game operation method of claim 10, wherein the points related to the completed bingo are related to the number of the completed bingo and the number of times the bingos are completed.

12: The sports bingo game operation method of claim 11, wherein the points related to the completed bingo are related to points related to daubing of the tiles completing the bingo.

13: The sports bingo game operation method of claim 1, wherein the determining comprises determining, by the processor, a ranking by applying a weight according to bingo directions of tiles completing the bingo.

14: The sports bingo game operation method of claim 1, further comprising:
storing, by the data processor, a gamer or a team lineup prepared by a user for a contest of a sports event selected by the user before the generating of the bingo game.

15: The sports bingo game operation method of claim 14, wherein at least some of the tiles of the bingo game correspond to gamer information included in the gamer lineup.

16: The sports bingo game operation method of claim 15, further comprising:
updating, by the data processor, the bingo game by changing an arrangement position of at least two tiles according to a movement command, and
the updating of the bingo game comprises changing gamer or team information corresponding to the tile according to the movement command.

17: The sports bingo game operation method of claim 14, wherein the storing comprises calculating a point related to a time required for determining the gamer lineup or a remaining time for completing lineup registration and storing the calculated point.

18: The sports bingo game operation method of claim 14, wherein the generating of the bingo game comprises generating, by the data processor, the bingo game such that each tile includes a plurality of daubing conditions.

19: The sports bingo game operation method of claim 18, wherein the determining comprises determining, by the data processor, whether each of the plurality of daubing conditions of the tile is daubed and determining whether the daubed tiles complete the bingo with the same daubing condition.

20: The sports bingo game operation method of claim 14, wherein the generating of the bingo game comprises generating, by the data processor, the bingo game such that each tile includes a plurality of daubing conditions and a daubing condition position of each of the plurality of daubing conditions.

21: The sports bingo game operation method of claim 20, wherein the daubing condition position is a position in a space or a position in order of the plurality of daubing conditions.

22: The sports bingo game operation method of claim 20, further comprising:
updating, by the data processor, the bingo game by changing a condition arrangement position of the daubing conditions of a designated tile according to a change command of the condition arrangement position.

23: The sports bingo game operation method of claim 20, wherein the determining comprises determining, by the data processor, whether each of the plurality of daubing conditions of the tile is daubed and determining whether the daubed tiles complete the bingo with the same daubing condition and daubing condition position.

24: The sports bingo game operation method of claim 14, wherein the determining comprises calculating, by the processor, a fantasy point of a gamer included in the lineup according to a predetermined fantasy point rule when a contest starts.

25: The sports bingo game operation method of claim 24, wherein the point related to the daubed tile is a fantasy point of a gamer corresponding to the daubed tile, and a point related to the completed bingo is a fantasy point of a gamer corresponding to a tile contributing to completion of the bingo.

26: The sports bingo game operation method of claim 25, wherein the ranking determining comprises determining the ranking on the basis of a point related to a time required for determining the gamer lineup or a remaining time for completing lineup registration, a point related to the completed bingo, at least one of points related to tiles not included in the completed bingo, and a fantasy point of gamers included in the lineup.

27: The sports bingo game operation method of claim 26, wherein the determining of the ranking comprises applying, by the data processor, a weight according to a bingo direction of the tiles completing the bingo to the point related to the completed bingo.
